(19) United States
(12) Patent Application Publication
(10) Pub. No.: US 2014/0274513 A1
(43) Pub. Date: Sep. 18, 2014

(54) CHAIN GUIDE

(71) Applicant: TSUBAKIMOTO CHAIN CO., Osaka (JP)

(72) Inventors: Yuichiro Ishikawa, Osaka-shi (JP); Masahiko Konno, Osaka-shi (JP)

(73) Assignee: TSUBAKIMOTO CHAIN CO., Osaka (JP)

(21) Appl. No.: 14/183,607

(22) Filed: Feb. 19, 2014

(30) Foreign Application Priority Data
Mar. 14, 2013 (JP) 2013-051794

(51) Int. Cl. F16H 7/18

(52) U.S. Cl. CPC F16H 7/18
USPC 474/140

(57) ABSTRACT

A chain guide is provided which has a simple configuration, decreases the occupation space inside an engine room, while maintaining the necessary strength, rigidity, and durability, reduces the number of production steps and material waste, reduces the production cost, prevents vibrations and breaks during the use, and has high utility. A chain guide includes a guide shoe and a base member supporting the guide shoe along the chain running direction. A first insertion groove for receiving insertion of one end portion of the base member to fix the same and a second insertion groove for receiving insertion of the other end portion to fix the same are provided below the running guide portion 111 of the guide shoe.

### BACKGROUND OF THE INVENTION

1. Field of the Invention

The present invention relates to a chain guide including a guide shoe slidingly guiding a running chain and a base member supporting the guide shoe along a chain running direction.

2. Description of the Related Art

A chain guide provided with a guide shoe that slidingly guides a running chain is commonly used for stabilizing the chain that runs between sprockets and maintaining the correct chain tension.

For example, FIG. 12 shows a well-known timing system of an engine in which a transmission chain CH such as an endless suspended roller chain is caused to run between sprockets S1, S2 provided at a crankshaft and a camshaft, respectively, inside an engine room E. In the system, the timing chain CH is endless suspended between the drive sprocket S1 mounted on the crankshaft inside the engine room E and a pair of driven sprockets S2 mounted on the camshaft, and the timing chain CH is guided by a swinging chain guide (swinging guide) 600 and a chain guide (fixed guide) 700.

In such a well-known timing system, the fixed guide 700 is fixed inside the engine room E by two mounting shafts Q, and the swinging guide 600 is mounted inside the engine room E such as to be capable of swinging in the suspension plane of the timing chain CH about the swinging shaft P as a center.

A chain tensioner T maintains the correct tension of the timing chain CH and inhibits vibrations by applying pressure to the swinging guide 600.

The conventional chain guide (swinging guide) 600 and chain guide (fixed guide) 700 for use in such timing systems are formed integrally from a synthetic resin. Therefore, in order to ensure rigidity and durability of the chain guide, it is necessary to increase the guide main body in size, thereby increasing the rigidity and durability. However, since practically the entire structure of the chain guide is located on the side opposite the chain running surface, when the guiding is performed from the outer circumferential side of the timing chain CH inside the engine room E, as in the example shown in FIG. 12, the guide main body cannot be enlarged on the inner circumferential side and a space should be ensured on the circumferential side. The resultant problem is that a compact engine room E is difficult to design.

Accordingly, a configuration is known (Japanese Patent Application Publication No. H10-89428) in which, in a chain guide (fixed guide) as shown in FIG. 13, only the running guide portion is formed from a low-friction resin material, and this resin material is supported by a material with high strength, rigidity, and durability, such as a metal, thereby reducing the occupation space, while ensuring the strength, rigidity, and endurance necessary for the chain guide as a whole.

For example, as shown in FIGS. 14 to 16, the well-known chain guide (fixed guide) 500 includes a guide shoe 510 made from a resin and slidingly guiding a running chain and a base member 520 made from a metal and supporting the guide shoe 510 along a chain running direction.

The base member 520 is constituted by a shoe support portion 521 extending in the chain running direction and base mounting portions 522 extending vertically at positions set apart with respect to the chain running direction. The two base mounting portions 522 are formed by bending at 90° with respect to the shoe support portion 521 from an integral metal sheet.

The two base mounting portions 522 are each provided with a mounting hole 523 for insertion of, for example, a bolt.

The guide shoe 510 is configured such that a running guide portion 511 is supported by the shoe support portion 521 of the base member 520, and end locking pieces 512 at both ends in the chain running direction and a plurality of side locking pieces 513 provided at appropriate locations in a width direction can be fitted by locking to the shoe support portion 521 and detached.

A lip 519 for introducing the chain so that the chain could be correctly mounted along the running guide portion 511 when the chain is assembled and for controlling the chain movement in the width direction when the chain is used is provided at each side of the running guide portion 511.

### SUMMARY OF THE INVENTION

In the above-described well-known chain guide 500, the shoe support portion 521 and two base mounting portions 522 are formed by bending the base member 520 at 90° at two locations of an integral metal sheet. The resultant problem is that where the accuracy of the two bent portions is low, strains appear in the base member 520 when it is fixed with bolts or the like to an engine or the like, the bolts can get loose and fall out due to running or engine vibrations, and cracks or fractures can appear in the base member 520 itself.

Where the bending processing is performed with a high accuracy to avoid the aforementioned problem, the production cost rises.

Further, in the boundary zone of the shoe support portion 521 and the vicinity of the center of the two base mounting portions 522, which are constituted by the integral metal sheet of the base member 520, internal stresses are concentrated during the bending operation and stress concentration easily occurs during the use. The resultant problem is that cracks and breaks easily occur and the sheet thickness should be increased.

Further, since the two base mounting portions 522 constituted by the integral metal sheet of the base member 520 are present at the same side surface, the pushing pressure of the chain creates a cantilever support during the use, thereby creating a load offset and also making it necessary to increase the sheet thickness in order to ensure a sufficient support. Further, since the two base mounting portions 522 should be fixed with bolts or the like to the engine, vibrations or noise generated in the base member 520 by the running chain are easily transmitted to the engine, and vibrations or noise of the entire engine are increased.

Furthermore, when the chain guide is used with a configuration with a different spacing of fixing portions inside an engine, a different base member 520 having two base mounting portions 522 should be used. The resultant problem is that specifications of a punching die or bending machine should be changed, which requires time and increases cost, and the degree of design freedom is low.

In addition, since the two base mounting portions 522 are provided at a single base member 520, it is difficult to share the base between engines with different mounting pitches.

It is an object of the present invention to provide a chain guide that has a simple configuration, decreases the occupation space inside an engine room, while maintaining the necessary strength, rigidity, and durability, reduces the number of production steps and material waste, reduces the production cost, prevents vibrations and breaks during the use, and has high utility.

The present invention resolves the above-described problem with a chain guide including: a guide shoe slidingly guiding a running chain; and a base member supporting the guide shoe along a chain running direction, this guide shoe having a running guide portion extending in the chain running direction and at least one shoe mounting portion extending perpendicular to the chain running direction, the chain guide further including an insertion groove, into which the base member can be inserted from a width direction to be fixed, below the running guide portion, the insertion groove being constituted by a first insertion groove for receiving insertion of one end portion of the base member to fix the same and a second insertion groove for receiving insertion of the other end portion to fix the same.

With the guide chain according to claim 1, the base member contributing to strength, rigidity, and durability is formed from a material other than that of the guide shoe and the occupation space can be reduced. Further, since the guide shoe has a shoe mounting portion and can have a simple shape making it possible to insert the base member into the insertion groove from the width direction, the number of places in the base member that are to be machined can be decreased and material waste can be reduced.

Further, since bending at 90° C. is unnecessary, cracks and breaks caused by stress concentration during the processing and use are eliminated and the sheet thickness can be reduced.

Since it is not necessary to fix the high-rigidity base member, no strains appear in the base member, it is not necessary to increase the processing accuracy, and the production cost can be reduced.

Further, since the high-rigidity base member is not in a direct contact with the engine, vibrations and noise of the base member generated by the running chain are not transmitted to the engine, and vibrations and noise of the entire engine are reduced.

Even when the chain guide is used in a configuration with a different distance between the fixing portions inside the engine, it is not necessary to change the shape of the base member, the degree of design freedom is high, and utility is high.

Further, since only the running guide portion may be functionally present between the first insertion groove and the second insertion groove of the guide shoe, this zone can be made thin and compact, the amount of guide shoe material can be reduced, the occupation space can be reduced, and heat radiation ability can be increased.

With the configuration described in claim 2, since the two end portions of the base material are inserted from the opposite directions in the width direction, the guide shoe and the base member can be stably fixed, and even if the base member shifts during the use, this shift can be minimized.

With the configuration described in claim 3, the guide shoe and the base member can be fixed even more stably.

With the configuration described in claim 4, since the guide shoe is formed from a synthetic resin material, a low-friction running guide portion can be obtained and molding is facilitated. Since the base member is made from a metal material, sufficient strength, rigidity, and durability can be maintained, while further reducing the occupation space.

Since the base member is formed by cutting the elongated metal material to a predetermined length, burrs caused by cutting or punching are not present on the surface in the longitudinal direction. Therefore, scratches of the contact surface of the guide shoe by burrs are prevented and the occurrence of cracks or breaks caused by the scratches during the use is prevented.

With the configuration described in claim 5, a high bending rigidity can be maintained despite a small thickness. Therefore, the amount of material used can be reduced, the weight can be decreased, and the material cost can be reduced.

With the configuration described in claim 6, bending rigidity can be increased in relation to a sheet thickness. Therefore, the amount of material used can be further decreased.

### BRIEF DESCRIPTION OF THE DRAWINGS

FIG. 1 is a perspective top view of the chain guide according to the first embodiment of the present invention;

FIG. 2 is a perspective bottom view of the chain guide according to the first embodiment of the present invention;

FIG. 3A, FIG. 3B, FIG. 3C, and FIG. 3D are respectively a plan view, a front view, a bottom view and a rear view of the chain guide according to the first embodiment of the present invention;

FIG. 4A and FIG. 4B are respectively a front view and a rear view of the guide shoe according to the first embodiment of the present invention;

FIG. 5 is a perspective view of the base member according to the first variation example of the first embodiment of the present invention;

FIG. 6A and FIG. 6B are respectively a perspective view and a side view of the base member according to the second variation example of the first embodiment of the present invention;

FIG. 7A and FIG. 7B are respectively a perspective view and a side view of the base member according to the third variation example of the first embodiment of the present invention;

FIG. 8A and FIG. 8B are respectively a perspective view and a side view of the base member according to the fourth variation example of the first embodiment of the present invention;

FIG. 9 is a perspective top view of the chain guide according to the second embodiment of the present invention;

FIG. 10 is a perspective bottom view of the chain guide according to the second embodiment of the present invention;

FIG. 11A, FIG. 11B, FIG. 11C, and FIG. 11D are respectively a plan view, a front view, a bottom view, and a rear view of the chain guide according to the second embodiment of the present invention;

FIG. 12 is an explanatory drawing of the conventional timing system of an engine;

FIG. 13 is an explanatory drawing of a conventional other timing system of an engine;

FIG. 14 is a perspective top view of the chain guide in FIG. 13;

FIG. 15 is a perspective bottom view of the chain guide in FIG. 13; and

FIG. 16A, FIG. 16B, and FIG. 16C are respectively a plan view, a front view, and a bottom view of the chain guide in FIG. 13.

### DESCRIPTION OF THE PREFERRED EMBODIMENTS

The present invention provides a chain guide including: a guide shoe slidingly guiding a running chain and a base member supporting the guide shoe along a chain running direction, wherein the guide shoe has a running guide portion extending in the chain running direction and at least one shoe mounting portion extending perpendicular to the chain running direction; an insertion groove into which the base member can be inserted from a width direction to be fixed below the running guide portion, hence as long as a chain guide is provided in a simple configuration, decreases the occupation space inside an engine room, while maintaining the necessary strength, rigidity, and durability, reduces the number of production steps and material waste, reduces the production cost, prevents vibrations and breaks during the use, and has high utility, then any specific configuration thereof is optional.

The base member is desirably from a metal material and is particularly preferred to be manufactured from a drawn material, but a well-known and appropriate material may be also selected according to the conditions such as rigidity, durability, formability, and cost.

It is desirable that the material of the guide shoe be a synthetic resin, but a well-known and appropriate material may be also selected according to the conditions such as friction resistance, rigidity, durability, formability, and cost.

### Example 1

A chain guide 100 (fixed guide) according to the first embodiment of the present invention will be explained hereinbelow with reference to the appended drawings.

The chain guide 100 is suitable for the above-described well-known timing system and includes, as shown in FIGS. 1 to 4, a guide shoe 110 slidingly guiding a running chain and a base member 120 supporting the guide shoe 110 along the chain running direction.

The base member 120 is constituted by a plate-shaped member extending in the chain running direction and is provided with a predetermined curved shape along the chain running direction.

The base member 120 has a uniform cross section in the chain running direction, and even when the base member is produced by punching from a rolled steel sheet, it may be cut to a predetermined length from an elongated material.

The guide shoe 110 is constituted by a running guide portion 111 extending along the chain running direction, and a shoe mounting portion 114 extending perpendicular to the chain running direction on the side of both ends in the chain running direction. The guide shoe is formed integrally, for example by injection molding, by using a synthetic resin material.

The guide shoe mounting portion 114 is formed to extend on the front surface at the upstream of the running guide portion 111 and on the rear surface at the downstream of the running guide portion 111, and provided with a mounting hole 115 for insertion of, for example, a bolt for fixing inside the engine room, and reinforced by a rib for maintaining strength and rigidity.

A first insertion groove 116 into which the base member 120 can be inserted from one side and in which the base member can be fixed is provided on the upstream side at the rear surface side of the running guide portion 111, and a second insertion groove 117 into which the base member 120 can be inserted from the opposite side and in which the base member can be fixed is provided on the downstream side.

In the present embodiment, a pushing protrusion 118 is provided inside the second insertion groove 117 and configured such that when the base member 120 is inserted, the pushing protrusion is elastically deformed to fix stronger the base member 120.

Lips 119 for introducing the chain so that the chain could be mounted correctly along the running guide portion 111 during the assembling and for controlling the chain movement in the width direction during the use are provided with appropriate spacing and length at both sides of the running guide portion 111.

In the present embodiment, the rightward direction in FIGS. 1 to 3 is to the upstream side in the chain running direction, and the leftward direction is to the downstream side in the chain running direction. The chain running surface side of the running guide portion 111 is taken as a front surface side and the surface opposite thereto is taken as a rear surface side.

In the chain guide 100 of the present embodiment that has the above-described configuration, the guide shoe 110 made from a low-friction synthetic resin is reinforced by the metallic base member 120 contributing to strength, rigidity and endurance. As a result, a comprehensive size reduction is achieved and more specifically the space occupied inside the engine room where the chain guide is to be fixed can be reduced.

Since the base member 120 is formed from a material with a uniform cross section, it can be easily manufactured by a simple method such as simple punching from a plate-shaped material or cutting an elongated material to an appropriate length, no material is wasted, and the production cost can be reduced.

In the case of manufacturing in which an elongated material is cut to an appropriate length, no burrs caused by cutting or punching are present on the surface in the longitudinal direction and a smooth surface can be obtained. Therefore, the guide shoe 110 is not scratched by the burrs, and the occurrence of cracks or breaks caused by scratches during the use can be prevented.

Further, since a zone where only the running guide portion 111 is present above the base member 120 is provided between the first insertion groove 116 and the second insertion groove 117, the amount of material of the guide shoe 110 can be reduced, the occupation space can be reduced, and heat radiation ability can be increased due to the exposure of the base member 120 made from a metal material.

Further, since the first insertion groove 116 and the second insertion groove 117 are provided such that the base member 120 can be inserted therein from mutually opposite directions in the width direction, the guide shoe 110 and the base member 120 can be stably fixed, and even if the base member 120 shifts during the use, this shift can be minimized.

In the present embodiment the shoe mounting portion 114 is formed to extend to the front surface side on the upstream side of the running guide portion 111 and to the rear surface side on the downstream side of the running guide portion 111. Therefore, the shoe mounting portion may be formed to extend in any direction and may have any shape on each side.

A locking portion to be locked to a mounting pin of an engine or the like may be provided instead of the mounting hole 115 provided in the shoe mounting portion 114.

The shoe mounting portion 114 of the guide shoe 110 may be provided only on one side and may be configured as a swinging guide mounted to enable swinging of the entire chain guide.

A depression may face the position corresponding to the pushing protrusion 118 inside the second insertion groove 117 of the base member 120. As a result, fixing by depression-protrusion engagement is enabled and the displacement in the chain running direction can be inhibited.

In the above-described embodiment, the base member 120 has a simple plate shape, but it can be also deformed variously.

For example, in the first variation example, as shown in FIG. 5, a base member 120A is constituted by a pipe-shaped metal drawn material having a hollow portion 124.

As a result, a high bending rigidity can be maintained even with a thin-wall configuration. Therefore, the amount of material used can be reduced, the weight can be decreased, and the material cost can be reduced.

In the second variation example, as shown in FIG. 6, a base member 120B has a plate-like shape and includes a protruding rib portion 125 extending uniformly in the chain running direction at both sides in the width direction.

As a result, a high bending rigidity can be maintained even with a thin-wall configuration, in the same manner as in the first variation example. Therefore, the amount of material used can be reduced, the weight can be decreased, and the material cost can be reduced.

In the third variation example, as shown in FIG. 7, a base member 120C has a plate-like shape and includes a depressed rib portion 126 extending uniformly in the chain running direction in the central portion in the width direction.

As a result, a high bending rigidity can be maintained even with a thin-wall configuration, in the same manner as in the first and second variation examples. Therefore, the amount of material used can be reduced, the weight can be decreased, and the material cost can be reduced.

In the fourth variation example, as shown in FIG. 8, a base member 120D is constituted by a pipe-shaped metal drawn material having the hollow portion 124 and has the depressed rib portion 126 extending uniformly in the chain running direction in the central portion in the width direction.

As a result, a high bending rigidity can be maintained even with a thin-wall configuration. Therefore, the amount of material used can be reduced, the weight can be decreased, and the material cost can be reduced.

### Example 2

A chain guide 200 (fixed guide) according to the second embodiment of the present invention will be explained below with reference to the appended drawings.

Similarly to the chain guide 100 according to the above-described first embodiment, the chain guide 200 is suitable for a well-known timing system, and as shown in FIGS. 9 to 11, includes a guide shoe 210 slidingly guiding a running chain and a base member 220 that supports the guide shoe 210 along the chain running direction.

The base member 220 is constituted by a plate-shaped member extending in the chain running direction and configured in a straight shape extending in the chain running direction.

The base member 220 has a uniform cross section in the chain running direction and may be cut to a predetermined length from an elongated material even when manufactured by punching from a rolled steel sheet.

The guide shoe 210 differs from the guide shoe 110 of the chain guide 100 according to the above-described first embodiment in that the thickness of the running guide portion 211 is changed so that the straight base member 220 could be inserted into the lower surface side of the running guide portion 211. Other basic features of the two guide shoes are the same (in the figure, the components of the present embodiment that correspond to the components assigned with reference numerals of a 100-order in the first embodiment are assigned with reference numerals of a 200-order).

Therefore, in the present embodiment, the processing of providing the base member 220 with a curved shape is not required and the production cost can be further reduced.

In the present embodiment, a lip-free configuration is described, but lips of appropriate spacing and length may be also provided.

Further, the base member 220 may have any cross-sectional shape. For example, the thickness, amount of material used, weight, and production cost can be reduced by using cross-sectional shapes similar to those of the variation examples of the first embodiment shown in FIGS. 5 to 8 described hereinabove.

The above-described embodiments are specific examples of the chain guide in accordance with the present invention, but the chain guide in accordance with the present invention is not limited thereto, and various modifications may be employed in terms of the shapes, positions, dimensions, and mutual arrangements of the constituent members.

Further, the configurations of the above-described embodiments are to be provided inside an engine having a timing system, but such an application is not limiting and they can be used in various devices.

Furthermore, the present invention can be applied not only to chain-based transmission mechanisms, but also to similar transmission mechanism using belts, ropes, and the like, and can be used in various industrial fields.

What is claims is:

1. A chain guide comprising: a guide shoe slidingly guiding a running chain; and a base member supporting the guide shoe along a chain running direction,
the guide shoe having a running guide portion extending in the chain running direction and at least one shoe mounting portion extending perpendicular to the chain running direction,
the chain guide further comprising an insertion groove, into which the base member can be inserted from a width direction to be fixed, below the running guide portion,
the insertion groove being constituted by a first insertion groove for receiving insertion of one end portion of the base member to fix the same and a second insertion groove for receiving insertion of the other end portion to fix the same.

2. The chain guide according to claim 1, wherein
the first insertion groove and the second insertion groove are provided to receive insertion of the base member from mutually opposing directions in the width direction.

3. The chain guide according to claim 1, wherein
a pushing protrusion that pushes the base member is provided inside at least one of the first insertion groove and the second insertion groove.

4. The chain guide according to claim 1, wherein
the guide shoe is formed from a synthetic resin material; and
the base member is formed from a metal material.

5. The chain guide according to claim 1, wherein the base member is formed in a shape of a pipe having a void inside thereof.

6. The chain guide according to claim 1, wherein the base member is formed in a shape having a protrusion and a depression in the width direction.
